(19) United States
(12) Patent Application Publication
(10) Pub. No.: US 2006/0039851 A1
(43) Pub. Date: Feb. 23, 2006

(54) Method of producing crystalline lithium/vanadium oxide powder

(75) Inventors: Arnaud Harabasz, Saint Marcel (FR); Christian Le Mouellic, Moutiers (FR); Lionel Pointu, Saint Marcel (FR); Pierre Flacher, Aigueblanche (FR)

Correspondence Address: CONNOLLY BOVE LODGE & HUTZ LLP, SUITE 800, 1990 M STREET NW, WASHINGTON, DC, 20036-3425, US

(73) Assignee: MSSA, Saint Marcel (FR)

(21) Appl. No.: 10/527,595

(22) PCT Filed: Sep. 10, 2003
(86) PCT No.: PCT/FR03/02685

§ 371 Date: Mar. 14, 2005

(30) Foreign Application Priority Data
Sep. 13, 2002 (FR) 02/11370

(51) Int. Cl. C01G 31/02

(52) U.S. Cl. 423/594.8

(57) ABSTRACT

This invention relates to a method for manufacturing a crystalline powder of a composite lithium and vanadium oxide with formula Li₁₊ₓV₃O₈, where x is between 0 and 0.2, comprising: formation of an aqueous suspension starting from an NH₄VO₃ paste and monohydrated lithia powder; continuous dehydration of this suspension in a hot gas current at a temperature of between 200 and 600° C., to form a dry powder of a precursor with a size grading of between 10 and 100 μm; calcination of this precursor at a temperature of between 380 and 580° C. to form a crystalline powder of Li₁₊ₓV₃O₈. The product thus obtained will be used particularly for manufacturing electrodes for lithium rechargeable batteries.

### TECHNICAL FIELD

This invention relates to a method for manufacturing a crystalline powder of a composite lithium and vanadium oxide with formula Li₁₊ₓV₃O₈, where ₓ is between 0 and 0.2. This product will be used particularly for manufacturing of electrodes for lithium rechargeable batteries.

State of the Art

All existing methods for the synthesis of Li₁₊ₓV₃O₈ composite oxide use the reaction of a vanadium compound on a lithium salt. They differ depending on whether or not they use a solvent.

The use of water as a solvent that leads to the formation of a gel is disclosed in patent US5039582 (PISTOÏA). This gel is obtained from LiOH and V₂O₅ after more than 24 hours, and is difficult to filter and to dry. Patent US U.S. Pat. No. 6,177,130 (FREY) describes an aqueous solution of lithia and vanadium acid prepared by passing ammonium metavanadate (MVA) on a resin. This solution is dried and its residue redissolved in an organic solvent to generate a product for application of an optical quality thin layer. For example, use of the organic solvent is mentioned in US patent U.S. Pat. No. 5,549,880 (KOKSBANG) and patent application WO 01/22507 (3M), but there are environment and safety problems at the industrial stage. Regardless of the solvent type, known methods are discontinuous and limited by the filtration step.

Without a solvent, it is possible to work on a mix of solids. The final compound is obtained by melting the mix as described in US patent 5013620 (Bridgestone) and in the article by A. D. WADSLEY, Acta Cryst. 10 (1957) 261, or a conversion slightly below the melting point as described in U.S. Pat. No. U.S. Pat. No. 5,520,903 (CHANG). These methods introduce the problem of transport and grinding of a material in molten or sintered blocks.

US patent U.S. Pat. No. 6,136,476 (Hydro-Quebec and 3M) discloses the mix of dry powders of a lithium compound and a vanadium compound, grinding by jet, and heating below the melting temperature. The method enables good control of the size grading in all manufacturing steps, with the number of steps being fairly limited.

However, the solid method has a number of disadvantages compared with the use of a solvent, which enables a more intimate mix of the reagents and therefore a more efficient reaction, and easier implementation. When synthesizing a crystallized material, crystallisation after solvation can take place at a lower temperature than with a solid method, which is more convenient and more economic. Finally, when one of the reagents is obtained in solution, the method with a solvent eliminates a drying step.

The purpose of the invention is to provide an almost continuous method for manufacturing a crystalline powder of Li₁₊ₓV₃O₈, that can be easily industrialised with a limited number of steps, in which the size grading can be controlled in each step, starting from ammonium metavanadate (MVA) and lithia reagents.

### OBJECT OF THE INVENTION

The object of the invention is a method for making a crystalline powder of a composite lithium and vanadium oxide with formula Li₁₊ₓV₃O₈, where ₓ is between 0 and 0.2, comprising:
formation of an aqueous suspension starting from an NH₄VO₃ paste and monohydrated lithia powder,
continuous dehydration of this suspension in a hot gas current at a temperature of between 200 and 600° C. to form a dry powder of a precursor with a size grading of between 10 and 100 μm,
calcination of this precursor at a temperature of between 380 and 580° C. to form a crystalline powder of Li₁₊ₓV₃O₈.

### DESCRIPTION OF THE INVENTION

The method begins by putting MVA paste and mono-hydrated lithia powder into an aqueous suspension, with a mass ratio such that the Li/V stoichiometry required to give Li₁₊ₓV₃O₈ is obtained, where ₓ is between 0 and 0.2. The ratio of solids to the total mass is between 40 and 60%.

The use of a solvent enables a more intimate mix of reagents and easier implementation than the solid method. Furthermore, in the special case of synthesis of a single-phase crystallized material, the solvent method requires lower crystallization temperatures than the solid method and therefore a lower energy cost.

The use of an aqueous solvent has a technical-economic advantage compared with the method described in US patent 6136476. The inorganic synthesis procedure of MVA imposes that it should be obtained in the wet state before calcination or drying. The drying step is not useful and the MVA (wet, paste or suspension) may be injected into the process directly, regardless of whether the MVA used is ultra-pure or is an intermediate product of V₂O₅ in the hydro-metallurgical cycle for the extraction of vanadium in a mining operation. Furthermore, recycling of the ammonia effluent may be economically and environmentally attractive, if combined with hydro-metallurgy of vanadium that consumes this gas.

The suspension thus obtained is kept stirred in a neutral atmosphere, for example a nitrogen atmosphere, for between ½ and 24 h and between 20 and 90° C., until it is added into a hot gas jet atomiser, for example a RINAJET atomiser made by the RIERA NADEU S.A. company. The strong turbulent flows of hot gases (250-600° C.) from this instrument enable instantaneous dehydration of the solid product and a precursor of the final product is obtained in the form of a dry powder with a size grading of between 10 and 100 μm.

The stirred suspension does not have the rheological characteristics of a gel and the dehydration technology used thus bypasses the difficult filtration step used by other methods according to prior art using the “sol-gel” method.

The powder obtained is loaded into a belt furnace performing the calcination step at between 380 and 580° C., avoiding re-agglomeration of the product. This step enables formation of the Li₁₊ₓV₃O₈ product crystallised without degrading the size grading that remains between 10 and 100 μm. This product may optionally be micronised and/or mixed with carbon black.

The method according to the invention enables less discontinuous operation than other methods using a solvent. The time necessary to create a contact in a suspension is shorter than the time necessary to form a gel. Thus, the difficult step of filtration of a gel is avoided, and on the contrary the suspension is dehydrated by continuously bringing it into a hot gas jet, for example using an instrument in the RINAJET product range (RIERA NADEU S.A.) with a high mass flow.

### DESCRIPTION OF THE FIGURES

FIG. 1 shows the diffraction diagram of the final product in example 1.

FIG. 2 shows the diffraction diagram of the final product in example 2.

### EXAMPLES

### Example 1

### Standard Purity LiV₃O₈

4872 g of ALDRICH MVA with purity 98.6% (dry weight) and 584 g of ALDRICH LiOH₃H₂O with purity 99.6% were put into suspension in distilled water, respecting the ratio of 300 ml of solvent per mole of LiV₃O₈.

The approximately 10 litres of suspension thus produced is kept stirred at 50° C. for 24 hours under nitrogen. It is added into a small scale model of instruments in the RINOJET commercial range made by the RIERA NADEU S.A. company at 1 l/h at a hot gas inlet temperature of 280° C.

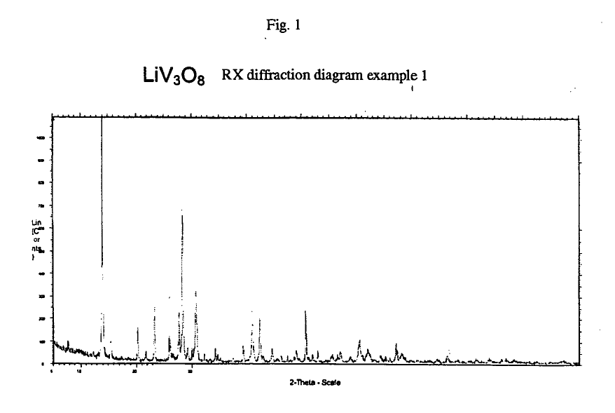

The dehydrated powder thus obtained is calcinated in a tray for 10 hours at 400° C. and the final result is a product identified by X diffraction as being LiV₃O₈ with V₂O₅ as an impurity, for which the most intense line is at 2θ=20.27°, as shown by the diagram in FIG. 1. This characterisation is made using a Siemens D-5000 diffractometer with the Kα line for copper, with 2θ varying from 5 to 100° in steps of 0.02° and 2 s per step. The product contains 2.35% of lithium and 52.2% of vanadium by weight, including 2.21% of V⁺⁴.

### Example 2

### High Purity LiV₃O₈

The first step is to use an innovative method to make high purity MVA, using 150 kg of VOCl₃ extracted from the applicant's standard production. This material is injected into a stirred reactor, into an NH₄OH solution previously prepared from 1 m³ of water and 90 kg of ammonia. The MVA is precipitated by controlling the temperature and the pH, and is washed and filtered on a fabric and is finally discharged in the form of a wet paste with a humidity of between 30 and 50%.

Two batches of the above method are used to extract 216 kg of high purity MVA (dry weight) for a wet weight of 336 kg, with the composition shown in table 1:

TABLE 1

| | | | | | | | | | | | | | | | |
|---|---|---|---|---|---|---|---|---|---|---|---|---|---|---|---|
| Element | Cl | V⁺⁴ | Fe | Na | Mo | K | Al | Si | Ca | Zn | Mg | Cu | Pb | Ni | Co |
| Content | 25 | 114 | 6 | 5 | 5 | 3 | 25 | — | 7 | 4 | 3 | 3 | 4 | 4 | <10 |
| (ppm) | | | | | | | | | | | | | | | |

31 kg of LiOH₃H₂O produced by the FMC company, dissolved in distilled water and then mixed with 336 kg of wet MVA, are used to obtain 320 l of suspension. Stirring is continued for 24 hours at 4° C. and the product is then added into the S1008 instrument in the RINOJET product range made by RIERA NADEU S.A. at 60 l/h at a gas inlet temperature of 350° C.

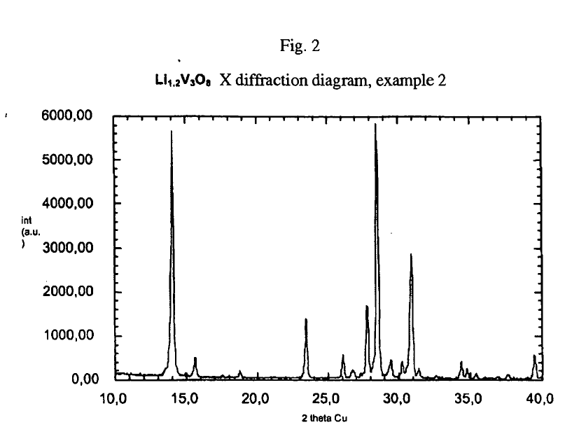

120 kg of dehydrated powder is recovered from this test, at 80° C. A few tens of kilograms of the extracted material are calcinated for 10 h at 400° C. The size grading of the final product measured by laser size grading on an instrument made by Malvern Instruments, is such that 90% of the powder by volume is smaller than 15.3 μm. The X-diffraction diagram shown in FIG. 2 is the diagram for an Li_{1.2} V₃O₈ crystal with LiVO₃ as the impurity, identifiable by its higher intensity peak at 2θ=18.64°. Characterisation is done on a Siemens D-500 diffractometer with the Kα line of copper, varying 20 from 10 to 70° C. in steps of 0.04° with 15 s per step. The composition of the product obtained is given in table 2:

TABLE 2

| | | | | | | | | | | | | | | | |
|---|---|---|---|---|---|---|---|---|---|---|---|---|---|---|---|
| Element | Li | V⁺⁴ | Fe | Na | Mo | K | Al | Si | Ca | Zn | Mg | Cu | Pb | Ni | Co |
| Content | 2.9% | 51% | 40 | 50 | 30 | 40 | 25 | <20 | 45 | 5 | 12 | 15 | <1 | 20 | 2 |
| (ppm) | | | | | | | | | | | | | | | |

1. Method for manufacturing a crystalline powder of a composite lithium and vanadium oxide with formula Li₁₊ₓV₃O₈, where x is between 0 and 0.2, comprising:
formation of an aqueous suspension starting from an NH₄VO₃ paste and monohydrated lithia powder,
continuous dehydration of this suspension in a hot gas current at a temperature of between 200 and 600° C. to form a dry powder of a precursor with a size grading of between 10 and 100 μm,
calcination of this precursor at a temperature of between 380 and 580° C. to form a crystalline powder of Li₁₊ₓV₃O₈.

2. Method according to claim 1, wherein the suspension is stirred before being injected into the hot gas current.

3. Method according to claim 1, wherein the size grading of the final product is between 10 and 100 μm.

4. Method according to claim 1, wherein the NH₄VO₃ paste is a high purity paste obtained by making VOCl₃ react with NH₄OH.

5. Method according to claim 2, wherein the size grading of the final product is between 10 and 100 μm.

6. Method according to claim 2, wherein the NH₄VO₃ paste is a high purity paste obtained by making VOCl₃ react with NH₄OH.

7. Method according to claim 3, wherein the NH₄VO₃ paste is a high purity paste obtained by making VOCl₃ react with NH₄OH.

8. A crystalline powder produced by a method of claim 1.

9. A crystalline powder produced by a method of claim 2.

10. A crystalline powder produced by a method of claim 3.

11. A crystalline powder produced by a method of claim 4.

12. An electrode suitable for a lithium rechargeable battery comprising a powder of claim 8.

13. An electrode suitable for a lithium rechargeable battery comprising a powder of claim 9.

14. An electrode suitable for a lithium rechargeable battery comprising a powder of claim 10.

15. An electrode suitable for a lithium rechargeable battery comprising a powder of claim 11.

16. A battery comprising a powder of claim 8.

17. A battery comprising a powder of claim 9.

18. A battery comprising a powder of claim 10.

19. A battery comprising a powder of claim 11.

20. A Li₁₊ₓV₃O₈ crystallized powder having a size from 10 to 100 μm that has been prepared without filtration of a gel.
